(19) United States
(12) Patent Application Publication
(10) Pub. No.: US 2023/0060677 A1
(43) Pub. Date: Mar. 2, 2023

(54) HIGH PRESSURE TANK WITH A BOSS PART WITH PLASTIC COATING

(71) Applicant: MAGNA Energy Storage Systems GesmbH, Grevenbroich (DE)

(72) Inventor: Mario DREBES, Sengenthal (DE)

(21) Appl. No.: 17/821,214

(22) Filed: Aug. 22, 2022

(30) Foreign Application Priority Data
Aug. 27, 2021 (EP) EP21193425.2

(51) Int. Cl. F17C 1/16

(52) U.S. Cl. CPC F17C 1/16; F17C 2203/0604; F17C 2203/066; F17C 2205/0305; F17C 2209/234; F17C 2221/012; F17C 2203/0619; F17C 2203/0675

(57) ABSTRACT

A high-pressure tank and a method of producing such a high-pressure tank. The high-pressure tank includes a liner composed of plastic, a shell of the liner, and at least one boss having at least at one contact surface with a plastic coating that contacts the liner. The plastic coating forms a seal between the at least one boss and the liner such that there are no other sealing elements therebetween.

### CROSS-REFERENCE TO RELATED APPLICATIONS

The present application claims priority 35 U.S.C. §119 to European Patent Publication No. EP 21193425.2 (filed on Aug. 27, 2021), which is hereby incorporated by reference in its entirety.

### TECHNICAL FIELD

One or more embodiments relate to a high-pressure tank comprising a liner made of plastic and a shell of the liner, and at least one boss.

### BACKGROUND

In a known design for high-pressure tanks, especially hydrogen tanks, an inner layer of the tank is formed from a plastic liner, for example from polyamide or polyethylene, and this liner is jacketed with a fibre material, for example with carbon fibres. A boss made of metal is typically inserted at the end of such a high-pressure tank, especially to receive a withdrawal apparatus, such as a withdrawal valve, for filling and withdrawal of the medium from the high-pressure tank.

A problem here is the binding of the boss to the liner, since reliable impermeability to counter escape of the medium, especially of hydrogen gas, has to be ensured between boss and liner. In order to achieve the high impermeability required, it is customary for multiple sealing elements, such as sealing rings, to be disposed between boss and liner. However, the use of additional mechanical sealing elements makes the production of the vessel more complicated and costly. The effect of the sealing elements can also decrease over the course of utilization of the high-pressure vessel.

### SUMMARY

It is an object of this disclosure to enhance a high-pressure tank of the type specified in this regard, and especially to specify a high-pressure tank that assures reliable impermeability between liner and boss and at the same time can be produced in a simple manner. It is a further object of this disclosure to specify a simple and inexpensive method of producing such a high-pressure tank having good impermeability between boss and liner.

The object is achieved by a high-pressure tank comprising a liner made of plastic and a shell of the liner, and at least one boss, wherein the boss makes contact with the liner at least at one contact surface, wherein the contact surface has a plastic coating, wherein the plastic coating constitutes the only seal between boss and liner, such that there are no other sealing elements between boss and liner.

In accordance with one or more embodiments, a boss is coated with a plastic in order to seal the boss with respect to the liner. The plastic of the plastic layer may especially be a plastic that is typically used as corrosion protection on metal parts, i.e. a corrosion protectant. The plastic may especially be nylon-11, also known by the name Rilsan®, or may be nylon-12. These plastics are known per se as corrosion protectant on metal parts.

In the context of this disclosure, it has been found that plastic corrosion protectants, especially nylon-11 and/or nylon-12, have excellent sealing properties at a contact surface between boss and plastic liner, such that such a coating of the boss can be used as a full replacement for otherwise customary sealing elements, such as sealing rings.

Developments of this disclosure are specified in the dependent claims, the description and the appended drawings.

The plastic coating is preferably a Rilsan® nylon-11 coating and/or has been applied to the boss in a Rilsan® coating method. Such a Rilsan® coating method is especially known from the company ARKEMA, for application of an anticorrosion layer to metal parts.

The plastic coating preferably has a thickness of 50-900 μm (micrometres), more preferably of 300-500 μm (micrometres).

The entire contact surface over which the boss comes into contact with the liner preferably has the plastic coating. The seal may then extend over the entire surface of the boss which is in contact with the liner. Alternatively, an only partial coating of the contact surface with the plastic is possible.

In accordance with one or more embodiments, a method of producing such a high-pressure tank comprises applying the plastic coating to the contact surface of the boss by powder coating, especially with nylon-11 or nylon-12, preferably by a sintering method such as fluidized bed sintering, or an electrostatic powder spraying method or flame spraying method.

The powder coating is preferably preceded by a chemical or mechanical pretreatment of the contact surface, more preferably a blasting operation, especially with white corundum.

The powder coating is preceded, and the chemical or mechanical pretreatment of the contact surface is preferably followed, preferably by application of a bonding primer to the contact surface, especially of a Primgreen® LAT 12035 bonding primer.

The powder coating of the boss preferably precedes the shaping production of the high-pressure tank. The coating can be bonded to the liner either by the rotomolding, thermoforming, blow molding or injection molding method.

Preferably, therefore, the powder coating of the boss creates a material bond to the liner of the high-pressure tank, either by the rotomolding, thermoforming, blow molding or injection molding method.

### DRAWINGS

One or more embodiments will be illustrated by way of example in the drawings and explained in the description hereinbelow.

FIG. 1 illustrates a perspective view of a boss of a high-pressure tank, in accordance with one or more embodiments.

FIG. 2 illustrates a sectional view of the boss of FIG. 1, bonded to a liner.

### DESCRIPTION

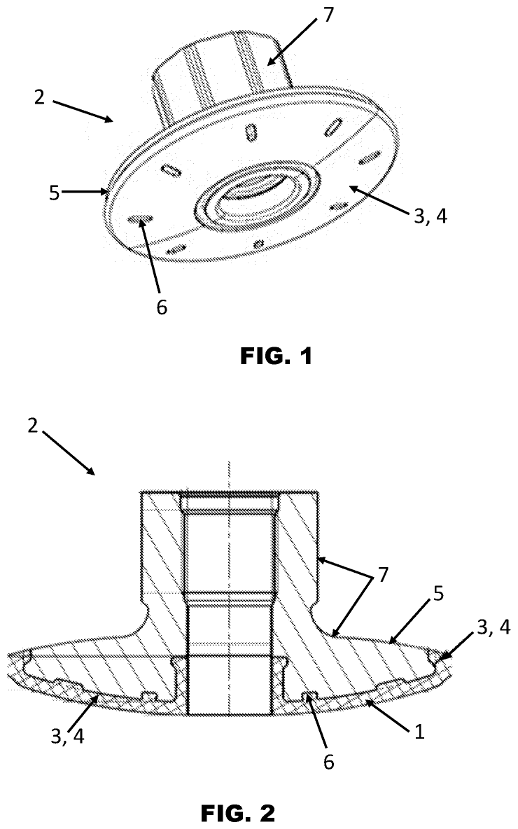

FIGS. 1 and 2 respectively illustrate a coated boss of a high-pressure tank according to this disclosure. FIG. 2 additionally illustrates a section of the liner 1 of a high-pressure vessel in the region of the boss 2.

As illustrated in FIG. 2, the high-pressure tank comprises a liner 1 made of plastic and a shell of the liner 1, typically comprising a fibre material embedded into a matrix (not illustrated). At at least one end face of the high-pressure tank, a boss 2 is used for withdrawal of the medium from the high-pressure tank. The boss 2 has a contact surface 3 with the liner 1. The boss 2 is essentially of cylindrical shape and has a collar 5 of greater circumference at its axial end facing the interior of the high-pressure tank. The underside of the collar 5 facing the interior of the high-pressure tank essentially forms the contact surface 3. The contact surface 3 preferably also comprises a radially inner axial section of the boss 2 that surrounds a central bore of the boss 2.

The boss 2 also has grooves 6 on the contact surface 3 that may, for example, run circumferentially, especially in the form of a circular segment and/or circle, and/or extend radially. The grooves 6 likewise form part of the coated contact surface 3. Grooves, and additional mechanical securing by means of undercuts and segments 6 on the sealing surface in general, may also be dispensed with completely by virtue of the coating depending on the embodiment. The function of assurance against rotation by the grooves 6 can be replaced by the two-dimensional coating. In general, a partial region with coating of the side 3, 4 facing the liner 1 may in some cases already be sufficient for the sealing and bonding function.

The contact surface 3 has at least partially or completely a plastic coating 4 of Rilsan® nylon-11 or comparable materials. The plastic coating 4 constitutes the sole seal between boss 2 and liner 1. No other sealing elements are disposed between the boss 2 and the liner 1.

The plastic coating 4 has a thickness of about 50-500 μm. The plastic coating 4 has been applied by a coating method, for example by means of powder coating with nylon-11, to the contact surface 3 of the boss 2. For this purpose, first of all, a region 7 of the boss 2 that was not to be coated was masked.

The coating was preceded by a chemical or mechanical pretreatment of the contact surface 3, preferably a blasting operation with white corundum.

After the chemical or mechanical pretreatment of the contact surface 3, a bonding primer is applied to the contact surface 3, for example a Primgreen® LAT 12035 bonding primer.

The material bond between coated surface of the boss (2) and the high-pressure tank (liner) is effected either by the rotomolding, thermoforming, blow molding or injection molding method.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 liner
2 boss
3 contact surface
4 plastic coating
5 collar
6 groove
7 uncoated region of boss

What is claimed is:

1. A high-pressure tank, comprising:
a liner composed of plastic;
a shell of the liner; and
at least one boss having at least at one contact surface with a plastic coating that contacts the liner, the plastic coating forming a seal between the at least one boss and the liner such that there are no other sealing elements therebetween.

2. The high-pressure tank of claim 1, wherein the plastic coating comprises a nylon-11 coating.

3. The high-pressure tank of claim 1, wherein the plastic coating comprises a a nylon-12 coating.

4. The high-pressure tank of claim 1, wherein the plastic coating comprises a Rilsan® polyamide-11 coating.

5. The high-pressure tank of claim 1, wherein the plastic coating is applied to the boss via a Rilsan® coating process.

6. The high-pressure tank of claim 1, wherein the plastic coating has a thickness in a range between 50-900 μm.

7. The high-pressure tank of claim 1, wherein the plastic coating has a thickness in a range between 300-500 μm.

8. The high-pressure tank of claim 1, wherein the plastic coating is applied on an entire contact surface on which the boss makes contact with the liner.

9. A high-pressure tank, comprising:
a liner composed of plastic; and
a boss having an uncoating region and a coated region that is coated with a plastic coating that contacts the liner, the coated region having at least at one contact surface with a plurality of grooves thereon that extend radially and are spaced apart circumferentially, the plastic coating forming a seal between the boss and the liner such that there are no other sealing elements therebetween.

10. The high-pressure tank of claim 9, wherein the plastic coating comprises a nylon-11 coating.

11. The high-pressure tank of claim 9, wherein the plastic coating comprises a a nylon-12 coating.

12. The high-pressure tank of claim 9, wherein the plastic coating comprises a Rilsan® polyamide-11 coating.

13. The high-pressure tank of claim 9, wherein the plastic coating is applied to the boss via a Rilsan® coating process.

14. The high-pressure tank of claim 9, wherein the plastic coating has a thickness in a range between 50-900 μm.

15. The high-pressure tank of claim 9, wherein the plastic coating has a thickness in a range between 300-500 μm.

16. The high-pressure tank of claim 9, wherein the plastic coating is applied on an entire contact surface on which the boss makes contact with the liner.

17. A method of producing a high-pressure tank, the method comprising:
applying a powder coating of plastic on at least at one contact surface of a boss, wherein the plastic coating is composed of Rilsan® polyamide-11 or polyamide-12.

18. The method of claim 17, further comprising, before applying the powder coating of plastic, performing a chemical pretreatment or a mechanical pretreatment of the at least one contact surface.

19. The method of claim 17, further comprising, after performing the chemical pretreatment or the mechanical pretreatment and before applying the powder coating of plastic, applying a bonding primer to the at least one contact surface.

20. The method of claim 17, further comprising, after applying the powder coating of plastic, shaping the liner while also bonding the plastic coating to the liner in the shaping of the liner.
